(19) United States
(12) Patent Application Publication
(10) Pub. No.: US 2011/0065345 A1
(43) Pub. Date: Mar. 17, 2011

(54) Impact Resistance Gypsum Wallboard and Method of Making the Same

(75) Inventors: John L. Phillips, Matthews, NC (US); Jennifer M. Willson, Chariotte, NC (US); Stephen L. LePage, Wilmington, NC (US)

(73) Assignee: National Gypsum Properties, LLC (a Limited Liability Company of the State of Delaware), Charlotte, NC (US)

(21) Appl. No.: 12/877,986

(22) Filed: Sep. 8, 2010

Related U.S. Application Data
(60) Provisional application No. 61/240,568, filed on Sep. 8, 2009.

(51) Int. Cl. B32B 13/02; B32B 7/04; B32B 13/08

(52) U.S. Cl. 442/34; 442/42; 156/42

(57) ABSTRACT

An impact resistant gypsum wallboard and method of making the same are disclosed that utilizes a woven scrim to improve upon the warping of the wallboard and to allow for a stronger bond to form between the facing material and gypsum core of the wallboard.

### RELATED APPLICATIONS

This U.S. Utility patent application claims priority to U.S. Provisional Patent Application 61/240,568, which was filed on Sep. 8, 2009.

### BACKGROUND

Conventional gypsum wallboard has been used for over fifty years in the construction of residential and commercial building interior walls and ceilings. Typically, wallboard consists essentially of a gypsum core sandwiched between and bonded to two sheets of facing material (e.g., paper) and is used as a cost-effective replacement of conventional plaster walls. To be commercially profitable, gypsum products, such as wallboard, are typically manufactured by continuous high speed processes. Typically, natural gypsum (calcium sulfate dihydrate) predominately makes up wallboard. Manufacturers mine and transport gypsum to a mill in order to dry it, crush/grind it and calcine it to yield stucco. The reaction for the calcination process is characterized by the following equation:

CaSO₄.2H₂O+heat→CaSO₄.½H₂O+1½H₂O

This equation shows that calcium sulfate dihydrate plus heat yields calcium sulfate hemihydrate (stucco) plus water vapor. This process is conducted in a calciner, of which there are several types known in the art. The stucco can contain one of two forms of calcium sulfate hemihydrate: the α-hemihydrate form and the β-hemihydrate form. These two types of stucco are often produced by different means of calcination. While the β-hemihydrate form is normally used due to its lower cost, either type of calcium sulfate hemihydrate is suitable for use.

Calcined gypsum (stucco) has the valuable property of being chemically reactive with water and will “set” rather quickly when the two are mixed together. This setting reaction reverses the above-described stucco chemical reaction performed during the calcination step. The reaction proceeds according to the following equation:

CaSO₄.½H₂O+1½H₂O→CaSO₄.2H₂O+heat

In this reaction, the calcium sulfate hemihydrate is rehydrated to its dihydrate state over a fairly short period of time. The actual time required for this setting reaction generally depends upon the type of calciner employed and the type of gypsum rock that is used. The reaction time can be controlled to a certain extent by the use of additives such as accelerators and retarders.

In known manufacturing processes for gypsum wallboard, the setting reaction is facilitated by premixing dry and wet ingredients in a mixing apparatus, such as a pin mixer. The dry ingredients can include, but are not limited to, any combination of calcium sulfate hemihydrate (stucco), fiberglass, and accelerator, and in some cases natural polymer (i.e., starch). The wet ingredients can be made of many components, including but not limited to, a mixture of water, paper pulp, and potash (hereinafter, collectively referred to as a “pulp paper solution”). The pulp paper solution provides a significant portion of the water that forms the gypsum slurry of the core composition of the wallboard. The dry ingredients and the pulp solution contain the basic chemical components of a piece of wallboard.

Conventional methods of preparing gypsum wallboard are well known to those skilled in the art. For example, the dry ingredients and pulp paper solution can be mixed together in a pin mixer. In this manner, the dry ingredients and pulp paper solution create a fluid mixture or “slurry.” The slurry is discharged from the mixer through the mixer's outlet chute or “boot”, which spreads the slurry on a moving, continuous bottom facing material. A moving, continuous top facing material is placed on the slurry and the bottom facing material, so that the slurry is positioned in between the top and bottom facing materials to form the board. The board can then pass through a forming station which forms the wallboard to the desired thickness and width. The board then travels along a belt line for several minutes, during which time the rehydration reaction occurs and the board stiffens. The boards are then cut into a desired length and then fed into a large, continuous kiln for drying. During drying, the excess water (free water) is evaporated from the gypsum core while the chemically bound water is retained in the newly formed gypsum crystals.

To increase the strength of the gypsum wallboard, a scrim can be embedded in the board close to the top facing material by laying the scrim on the slurry and bottom facing material. Once the scrim is placed on the slurry, the slurry will be able to pass through the openings of the scrim and the scrim will become embedded in the slurry. The top facing material is then placed on top of the scrim, the slurry and the bottom facing material to form the board. As the gypsum slurry rehydrates, new gypsum crystals will form and bond the gypsum core to the top facing material and the scrim.

The embedded scrim provides greater impact resistance properties to the wallboard that meet the specifications set forth in ASTM International's Standard Classification for Abuse-Resistant Nondecorated Interior Gypsum Panel Products and Fiber-Reinforced Cement Panels (ASTM C1629) and makes it ideal for use in high traffic areas (e.g., such as dormitories, hospitals, etc.). As shown in FIG. 1, such scrims have a grid or lattice construction, where vertical yarns 20 and horizontal yarns 21 are laid on top of each other at right angles to create a scrim. In order to keep the yarns in the desired right-angled position, the yarns are bonded together through a resin coating process. Such a scrim is generally referred to as a “laid scrim”. The laid scrim can generally be made of any commercially acceptable material. Such materials include PVC coated fiberglass, basalt fibers, carbon fibers, polypropylene, and alkali resistant glass.

During manufacturing of wallboards with paper facing materials, the top and bottom facing materials expand as they get wet and the gypsum core expands as the stucco rehydrates. For impact resistant boards, the laid scrim does not expand because it is dimensionally stable and it is not impacted by temperature or moisture. When the laid scrim is bonded to the top facing material through the formation of gypsum crystals, the laid scrim inhibits the top facing material from expanding. As a result, the board begins to warp or cup (i.e., the edges curl up on the belt line as much as ⅜^{th} of an inch) because the bottom facing material and gypsum core still expand while the top facing material and scrim do not.

A warped board has a greater tendency to crack during flipping and handling of the wallboard in the manufacturing process. Moreover, because the scrim inhibits the top facing material from expanding, the top facing material can become very wrinkly and as a result, have a weak bond to the gypsum core. During the drying process, vapor pressure can build up around the top facing material. If the bond between the top facing material and gypsum core is not strong enough, the top facing material can become detached from the gypsum core. Such problems lead to an increased amount of faulty wallboard that is produced and must be discarded.

Thus, it is desirable to use a scrim that reduces the amount of warping of the wallboard that occurs during the manufacturing process, without reducing the impact resistance of the board. It is also desirable that such a scrim allows for a stronger bond to form between the facing material and gypsum core to prevent the facing material from becoming detached during the drying process.

### DESCRIPTION OF THE DRAWINGS

FIG. 1 shows a diagram of the prior art configuration of a laid scrim used in impact resistant gypsum wallboard;

FIG. 2 shows a cross sectional view of an impact resistant gypsum wallboard using a woven scrim;

FIG. 3 shows the configuration of a leno woven scrim that can be used to replace the prior art laid scrim;

FIG. 4a shows the configuration of a plain woven scrim that can be used to replace the prior art laid scrim;

FIG. 4b shows the configuration of a basket woven scrim that can be used to replace the prior art laid scrim;

FIG. 4c shows the configuration of a mock leno woven scrim that can be used to replace the prior art laid scrim;

FIG. 4d shows the configuration of a twill woven scrim that can be used to replace the prior art laid scrim; and

FIG. 4e shows the configuration of a satin woven scrim that can be used to replace the prior art laid scrim.

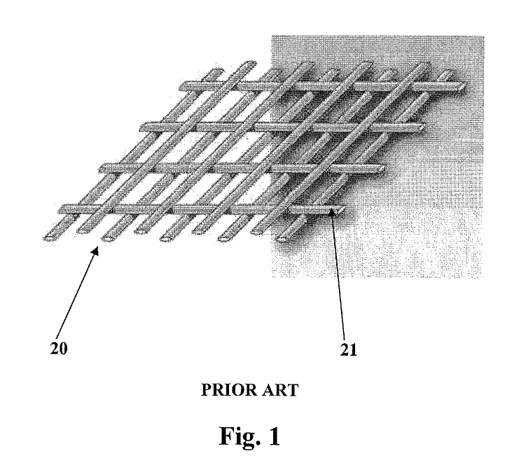

### SUMMARY

As discussed herein, an impact resistant gypsum wallboard and method of making the same is disclosed that reduces the amount of warping of the wallboard during the manufacturing process, without reducing the impact resistance of the board. Such a gypsum wallboard comprises a typical construction of a gypsum core positioned in between a first facing material and a second facing material. A woven scrim is embedded in the gypsum core near or adjacent to one of the first or second facing materials. The woven scrim is positioned in a plane that is substantially parallel to both the first and second facing materials.

The woven scrim has a nominal mesh size that ranges from about 2 yarns per inch by about 2 warp yarns per inch (2×2) to about 5 weft yarns per inch by about 5 warp yarns per inch (5×5). The woven scrims can be strengthened by coating the scrim with a resin and can comprise any number of types of woven scrims, including, a leno scrim, a plain woven scrim, a basket woven scrim, a mock leno woven scrim, a twill woven scrim, or a satin woven scrim. In one embodiment, the woven scrim comprises a leno scrim made up of weft rovings with a break strength of at least about 134 pounds-force per inch and warp rovings with a break strength of a least about 184 pounds-force per inch. In such an embodiment, the rovings are made up of fiberglass fibers where the warp rovings have a yield of 1200 and the weft rovings have a yield of about 827.

Such a wallboard can be made by depositing a slurry made up of at least stucco and water on a first facing material, embedding a woven scrim in the slurry, and placing a second facing material on top of the slurry, woven scrim and first facing material. In this manner, the woven scrim is positioned near or adjacent to the second facing material and the woven scrim is positioned in a substantially parallel plane to the second facing material. Alternatively, the woven scrim can be placed on top of the first facing material and the slurry can be deposited on top of the woven scrim and facing material so that the woven scrim is embedded in the slurry. In this manner, the woven scrim is positioned near or adjacent to the first facing material and the woven scrim is positioned in a substantially parallel plane to the first facing material.

### DETAILED DESCRIPTION

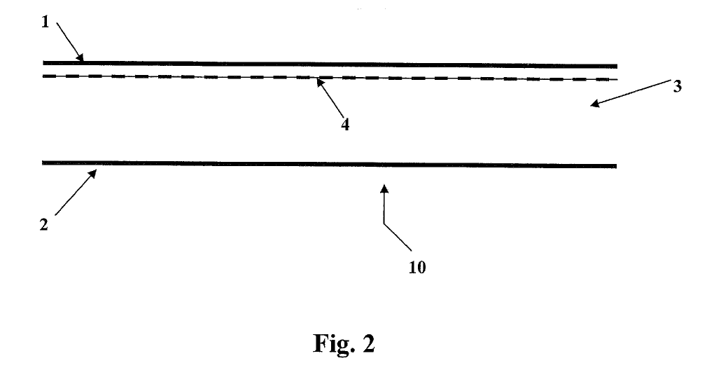

FIG. 2 shows a cross-sectional view of an impact resistant gypsum wallboard 10. As shown in FIG. 2, the gypsum wallboard 10 comprises a top facing material 1, a bottom facing material 2, a gypsum core 3 and a woven scrim 4. As shown in FIG. 2, the gypsum core 3 is sandwiched in between top and bottom facing materials 1 and 2 and scrim 4 is embedded in gypsum core 3 near and/or adjacent to top facing material 1. Scrim 4 is placed in a plane that is substantially parallel to both the top and bottom facing materials 1 and 2 so that the width and length of the scrim is substantially parallel to the width and length of the top and bottom facing materials. It will be appreciated by one skilled in the art that if the scrim is embedded too close to the center of the gypsum core of the wallboard that it may cause difficulties in cutting the board during the manufacturing process.

In this embodiment, top facing material 1 will become the back of the wallboard and bottom facing material 2 will become the front of the wallboard. It will be appreciated by one of ordinary skill in the art that any number of facing materials can be used to create gypsum wallboard 10, including, but not limited to, sheets of paper or sheets of fiberglass. However, it should be noted that if fiberglass is used as the facing material, the produced wallboard, regardless of the type of scrim used, does not exhibit the same warping problems as using paper as the facing material.

Woven scrim 4 is either made up of yarns or rovings that are woven together in any number of formations. Yarns comprise a group of individual fibers bundled together, normally by a twisting process, to form each yarn. Instead of yarns, rovings can also be used to form the woven scrim. Rovings are formed by laying the individual fibers together in a substantially parallel fashion and binding them together through known binding techniques. When rovings are formed into composites, either woven or non-woven, the resulting product is thinner and more flexible than an equivalent composite made of yarn. It will be appreciated by one skilled in the art that either yarns or rovings may be used to create the woven scrims and the term “end”, as used herein, shall mean either yarns or rovings. Moreover, while measurements disclosed herein refer to yarns (e.g., yarns per inch), it will be understood that the same measurements apply to rovings as well.

Woven scrims described herein can be made up of any of a number of commercially available materials that exhibit the desired strength for a manufacturer. Such materials include, but are not limited to, fiberglass, carbon fibers, basalt fibers, alkali resistant glass, nylon fibers, and polypropylene fibers. While any of these types of materials can be used, it will be appreciated by one skilled in the art that the strength of the material used will impact the ease of which the wallboard can be cut during the manufacturing process. Accordingly, manufacturers will want to select scrims that not only impart the desired strength characteristics on the finished wallboard but also allow for the board to be cut in the manufacturing process. For example, woven scrims that have a break strength of about 40 pounds-force per end to about 60 pounds-force per end have been found to impart the desired strength characteristics on the finished board, but depending on the nominal construction of the scrim, manufacturers may want to use woven scrims that have ends with lower or higher break strengths.

The mesh size of the woven scrim can generally be of any mesh size that allows the gypsum slurry to pass through the scrim. The nominal construction or nominal mesh size is typically measured by yarns per inch and is given as a number by number value that corresponds to the number of weft yarns and warp yarns present in an inch of the scrim. Exemplary nominal constructions include, but are not limited to, 2 weft yarns per inch by 2 warp yarns per inch (2×2), 2 weft yarns per inch by 2.5 warp yarns per inch (2×2.5), 2 weft yarns per inch by 5 warp yarns per inch (2×5.0), 3 weft yarns per inch by 3 warp yarns per inch (3×3), 4 weft yarns per inch by 4 warp yarns per inch (4×4) or 5 weft yarns per inch by 5 warp yarns per inch (5×5). Smaller numbers of yarns per inch correspond to larger mesh sizes, and larger openings in the mesh. The break strength of the woven scrim can be measured in pounds-force per inch by multiplying the break strength per end (pounds-force per end) by the nominal construction of the scrim.

The woven scrims can also be strengthened by coating the scrim with a resin. While uncoated, woven scrims have some structural stability, the stability and strength of a woven scrim can be enhanced by coating the woven scrim with a resin. Typically, the coating occurs by a dipping process where the scrim is dipped into a bath of a suitable resin. Suitable resins that can be used to coat the scrim include, but are not limited to, acrylics and plasticized polyvinyl chloride (PVC). It will be appreciated by one of ordinary skill in the art that other resins can be used to coat the scrims as well.

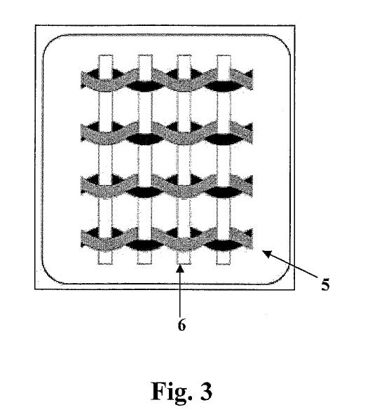

Any number of woven scrims can be used to construct the wallboard. For example, FIG. 3 shows a woven scrim configuration, known as a “leno scrim”, that can be used in constructing the wallboard. As shown in FIG. 3, a leno scrim has “fill” or “weft” ends 5 (i.e., horizontal ends) that are wrapped and/or twisted around “warp” ends 6 (i.e., vertical ends) to lock the ends in place in a woven configuration. While a leno scrim can comprise ends made from any number of materials, it is preferred that the ends of the leno scrim be made up of fiberglass due to its low cost and relative high strength characteristics.

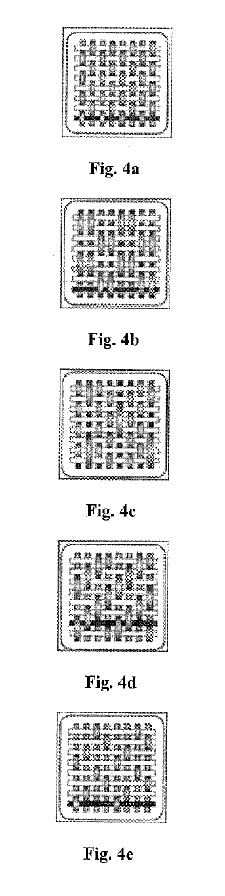

While a leno scrim is shown in FIG. 3, it will be appreciated that other woven scrims can be used. For example, FIG. 4a shows a plain woven scrim configuration, where the ends cross over and under one another to create the woven scrim. FIG. 4b shows a basket woven scrim configuration, where sets of two weft ends cross over and under other sets of two warp ends to create the woven scrim. FIG. 4c shows a mock leno woven scrim configuration, where ends run in groups both vertically and horizontally, locking each other in place at the interlacing. FIG. 4d shows a twill woven scrim configuration, where the interlacing of the ends is arranged in such a fashion to form a distinct diagonal line on the scrim surface. FIG. 4e shows a satin woven scrim configuration, where the warp ends cross over three or more consecutive weft ends, then under the next weft end, back over three or more consecutive weft ends, and such pattern is repeated until the scrim is completed. Similarly, the weft ends of the satin woven scrim passes over three or more of consecutive warp ends, then under the next warp end, back over three or more consecutive warp ends, and such pattern is repeated until the scrim is completed. While several exemplary woven scrims are described herein, it will be appreciated by one skilled in the art that any type of woven scrims can be used.

The above described wallboards can be prepared by any of a number of known methods for manufacturing gypsum wallboard. For example, a gypsum slurry can be produced by mixing a number of dry and wet ingredients in a mixing apparatus (e.g., a pin mixer) in any number of known formulations in the art. As noted in the background section, the dry ingredients can include, but are not limited to, any combination of calcium sulfate hemihydrate (stucco), fiberglass, and accelerator, and in some cases natural polymer (i.e., starch). The wet ingredients can be made up of many components, including but not limited to, a mixture of water, paper pulp, biocides, foam, and potash (hereinafter, collectively referred to as a “pulp paper solution”). The pulp paper solution provides a significant portion of the water that forms the gypsum slurry of the core composition of the wallboard. The dry and wet ingredients are mixed together to create a slurry.

To create the board, a bottom facing material is placed onto a conveyor belt and is transported by the conveyor belt so that it passes underneath a slurry discharge. The slurry is discharged from the mixer through the mixer's outlet chute or “boot”, which spreads the slurry on the bottom facing material. Once the slurry is deposited on the bottom facing material, a moving continuous woven scrim is placed on top of the slurry and bottom facing material through the use of a conveyor system. The slurry passes through the openings of the scrim and the scrim becomes embedded into the slurry.

A moving, continuous top facing material is placed on top of the embedded scrim, the slurry and bottom facing material through the use of another conveyor system. In this manner, the slurry with the embedded woven scrim is positioned in between the top and bottom facing materials to form the board; so that, as shown in FIG. 2, the embedded scrim is in a parallel plane and near and/or adjacent to the top facing material. The board can then pass through a forming station, which forms the wallboard to the desired thickness and width. The board then travels along a belt line for several minutes, during which time the rehydration reaction occurs and the board stiffens. The boards are then cut into a desired length and fed into a large, continuous kiln for drying. During drying, the excess water (free water) is evaporated from the gypsum core while the chemically bound water is retained in the newly formed gypsum crystals.

While the scrim is placed on top of the slurry prior to the top facing material being placed on top of the scrim, slurry and bottom facing material, it will be appreciated that the scrim could also be placed on the bottom facing material prior to the slurry being deposited on the bottom facing material. In this manner, once the bottom facing material and scrim are passed under the slurry discharge, the slurry will pass through the openings of the scrim and embed the scrim in the slurry near and/or adjacent to the bottom facing material.

The overall thickness of the wallboard can generally be any thickness commonly used in the construction industry. Generally, the wallboard can be about ¼ inch (0.64 cm) or greater in thickness. For example, the wallboard can have a thickness of about ¼ inch (0.64 cm), about 5/16 inch (0.79 cm), about ½ inch (1.27 cm), about ⅝ inch (1.6 cm), about ¾ inch (1.90 cm), or about 1 inch (2.54 cm).

The width of the wallboard can generally be any width commonly used in the construction industry. For example, the width can be about 32 inches (81 cm), about 36 inches (91 cm), about 48 inches (122 cm), or about 54 inches (137.2).

The length of the wallboard can generally be any length commonly used in the construction industry. For example, the length can be about 60 inches (152 cm), about 72 inches (183 cm), about 96 inches (244 cm), about 120 inches (304 cm), and 144 inches (366 cm).

Referring back to FIG. 3, one embodiment of the leno scrim has fill/weft fiberglass rovings 5 with a break strength of at least about 134 pounds-force per inch and has warp fiberglass rovings 6 with a break strength of at least 184 pounds-force per inch. The fill/weft rovings used to create the scrim have a yield of about 827 and the warp rovings have a yield of 1200. In this embodiment, the uncoated, finished scrim has a fabric weight of 4.14 ounces per yard squared and a nominal mesh size of 2.5 fill yarns per inch by 5.0 warp yarns per inch. In this embodiment, once the scrim is coated with PVC, the coated scrim has a weight of 5.4 ounces per yard squared. Such a leno scrim is commercially available from Textum Weaving, Inc. It will be appreciated by one skilled in the art that this embodiment is only one example of a leno scrim that can be used and leno scrims with various fabric weights, coated weights and various nominal mesh sizes can be used instead.

It has been found that gypsum wallboard produced with paper facing materials and this embodiment of the leno scrim reduce the warping of the board by up to 75% over gypsum wallboards that are produced with paper facing materials and a laid scrim. It has also been found that the use of a leno scrim results in the top facing paper being smoother. The reduction of the warping results in fewer cracked boards. The smoother top facing paper allows for a stronger bond to form between the gypsum core and top facing paper, which in turn reduces the tendency of the top facing paper to become detached during the wallboard drying process. As a result, an increase in quality boards produced and a decrease in boards that need to be discarded have been observed. It has also been determined that the use of this embodiment of the leno scrim allows for the use of a less fluid slurry.

While various embodiments of gypsum wallboard constructions using woven scrims have been described in considerable detail herein, the embodiments are merely offered by way of non-limiting examples of the disclosure described herein. It will therefore be understood that various changes and modifications may be made, and equivalents may be substituted for elements thereof, without departing from the scope of the disclosure. This disclosure is not intended to be exhaustive or to limit the scope of the disclosure.

Further, in describing representative embodiments, the disclosure may have presented a method and/or process as a particular sequence of steps. However, to the extent that the method or process does not rely on the particular order of steps set forth herein, the method or process should not be limited to the particular sequence of steps described. Other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

We claim:

1. A gypsum wallboard comprising:
a first facing material;
a second facing material;
a gypsum core positioned in between the first and second facing material; and
a woven scrim embedded in the gypsum core positioned near the first facing material,
wherein the woven scrim and first facing material are positioned in parallel planes to one another.

2. The gypsum wallboard of claim 1, wherein the first and second facing materials each comprise paper.

3. The gypsum wallboard of claim 1, wherein the woven scrim has a nominal construction that ranges from about 2 weft ends per inch by about 2 warp ends per inch to about 5 weft ends per inch by about 5 warp ends per inch.

4. The gypsum wallboard of claim 1, wherein the woven scrim comprises a woven scrim with a resin coating.

5. The gypsum wallboard of claim 1, wherein the woven scrim comprises a leno scrim.

6. The gypsum wallboard of claim 1, wherein the woven scrim comprises a leno scrim made up of a plurality of weft rovings with a break strength of at least about 134 pounds per inch and a plurality of warp rovings with a break strength of at least 184 pounds per inch.

7. The gypsum wallboard of claim 1, wherein the woven scrim comprises a plain woven scrim.

8. The gypsum wallboard of claim 1, wherein the woven scrim comprises a basket woven scrim.

9. The gypsum wallboard of claim 1, wherein the woven scrim comprises a mock leno woven scrim.

10. The gypsum wallboard of claim 1, wherein the woven scrim comprises a twill woven scrim.

11. The gypsum wallboard of claim 1, wherein the woven scrim comprises a satin woven scrim.

12. A method of manufacturing gypsum wallboard, the method comprising the steps of:
providing a slurry made up of at least stucco and water;
providing a first facing material and a second facing material;
depositing the slurry on the first facing material;
embedding a woven scrim in the slurry; and
placing the second facing material on top of the slurry, woven scrim and first facing material, so that the woven scrim is positioned near the second facing material and the woven scrim and the second facing material are positioned in substantially parallel planes to one another.

13. The method of manufacturing gypsum wallboard of claim 12, wherein the woven scrim comprises a woven scrim with a resin coating.

14. The method of manufacturing gypsum wallboard of claim 12, wherein the woven scrim comprises a leno scrim.

15. The method of manufacturing gypsum wallboard of claim 12, wherein the woven scrim comprises a leno scrim made up of a plurality of weft rovings with a break strength of at least about 134 pounds-force per inch and a plurality of warp rovings with a break strength of a least 184 pounds-force per inch.

16. A method of manufacturing gypsum wallboard, the method comprising the steps of:
providing a slurry made up of at least stucco and water;
providing a first facing material and a second facing material;
placing a woven scrim on the first facing material;
depositing the slurry on the woven scrim and first facing material, so that the woven scrim is embedded in the slurry in a position near the first facing material and in a plane that is substantially parallel to the plane of the first facing material.

17. The method of manufacturing gypsum wallboard of claim 16, wherein the woven scrim comprises a woven scrim with a resin coating.

18. The method of manufacturing gypsum wallboard of claim 16, wherein the woven scrim comprises a leno scrim.

19. The method of manufacturing gypsum wallboard of claim 16, wherein the woven scrim comprises a leno scrim made up of a plurality of weft rovings with a break strength of at least about 134 pounds-force per inch and a plurality of warp rovings with a break strength of a least 184 pounds-force per inch.
